(19) United States
(12) Patent Application Publication
(10) Pub. No.: US 2022/0356800 A1
(43) Pub. Date: Nov. 10, 2022

(54) Drilling Quasi-Stationary Data Extraction And Processing

(71) Applicant: Halliburton Energy Services, Inc., Houston, TX (US)

(72) Inventors: Jie Yang, Houston, TX (US); Daniel L. Miller, Houston, TX (US)

(73) Assignee: Halliburton Energy Services, Inc., Houston, TX (US)

(21) Appl. No.: 17/382,766

(22) Filed: Jul. 22, 2021

Related U.S. Application Data
(60) Provisional application No. 63/181,541, filed on Apr. 29, 2021.

(51) Int. Cl. E21B 47/04; E21B 44/00; G06N 3/08

(52) U.S. Cl. CPC E21B 47/04; E21B 44/00; G06N 3/08; E21B 2200/22

(57) ABSTRACT

A method for assessing and/or removing one or more motion effects from logging while drilling (LWD) measurement data may include disposing a borehole logging tool into a borehole, wherein the borehole logging tool is disposed on a bottom hole assembly (BHA), taking one or more measurements at one or more depth in the borehole with the borehole logging tool to form a measurement data set, and identifying one or more pipe breaks and one or more stations in the measurement data set. The method extracts measurement data at one or more pipe breaks and one or more stations to form a non-motion measurement data set, providing answer products from the non-motion measurement data set. The method may further include removing the one or more pipe breaks and one or more stations from the measurement data set to form a corrected measurement data set and providing one or more answer products.

### BACKGROUND

In order to obtain hydrocarbons such as oil and gas, boreholes are drilled through hydrocarbon-bearing subsurface formations. During drilling, logging tools may operate to determine the properties of formations surrounding the borehole as well as the borehole itself. In measurement-while-drilling (MWD) or logging-wile-drilling (LWD) techniques, the testing equipment (or logging tools) may be conveyed down the borehole along with the drilling equipment. Some logging tools, taking measurements during drilling operations, may include resistivity, gamma radiation, seismic imaging, sonic logging, nuclear magnetic resonance logging, and/or the like.

During drilling operations, motion effects are common for LWD tools to experience. Drilling dynamics often impact sensor raw measurements and are more pronounced for tools with low signal to noise ratio (SNR), without limitation, such as a nuclear magnetic resonance (NMR) tool. As discussed below, low SNR may affect data acquisition and subsequent data processing. As a result, various correction methods may be utilized to correct the raw measurements and/or intermediate and final processed results that may have skewed data from motion effects. Due to the complexity of drilling dynamics, complete and accurate correction methods may be quite challenging.

### BRIEF DESCRIPTION OF THE DRAWINGS

These drawings illustrate certain aspects of some examples of the present disclosure and should not be used to limit or define the disclosure.

FIG. 1 illustrates an example of a drilling system.

FIG. 2 illustrates an example of a machine learning system.

FIG. 3A shows a graph of current extraction methods for finding and displaying logging tool depths.

FIG. 3B shows a graph of a Depth Plot after applying the proposed quasi station extraction method using default Quasi-Stationary Data Extraction Method parameters.

FIG. 3C shows a graph of data as shown in FIG. 2A but “zoomed in” to a depth interval to show more detail.

FIG. 3D shows a graph of data in 2B but “zoomed in” to show more detail.

FIG. 4A shows a graph of a drilling log that includes measurements of a logging tool.

FIG. 4B is a magnification of a set of measurements on FIG. 4A.

### DETAILED DESCRIPTION

Logging-while-drilling (LWD) measurement data without motion effects, that occur during drilling pipe breaks, may be utilized to assess and/or correct other measurements taken during logging operations. The corresponding information extracted may be used for both quality control (QC) and as well as high quality “stations” that may be delivered to our clients as an additional answer product. The proposed algorithm extracts data collected during drilling pipe breaks to improve answer products by taking advantage of measurement data taken during stationary periods of drilling operations. Answer products may include, but are not limited to, T₁and/or T₂ distributions, T₁ and/or T₂ porosities of a subterranean formation, nuclear magnetic resonance (NMR) permeability,

$$\frac{{T}_{1}}{{T}_{2}}$$

ratio, and/or various T₁ and/or T₂ QC curves for the case of NMR acquired data. Other separate answer products result from other LWD tool acquired data.

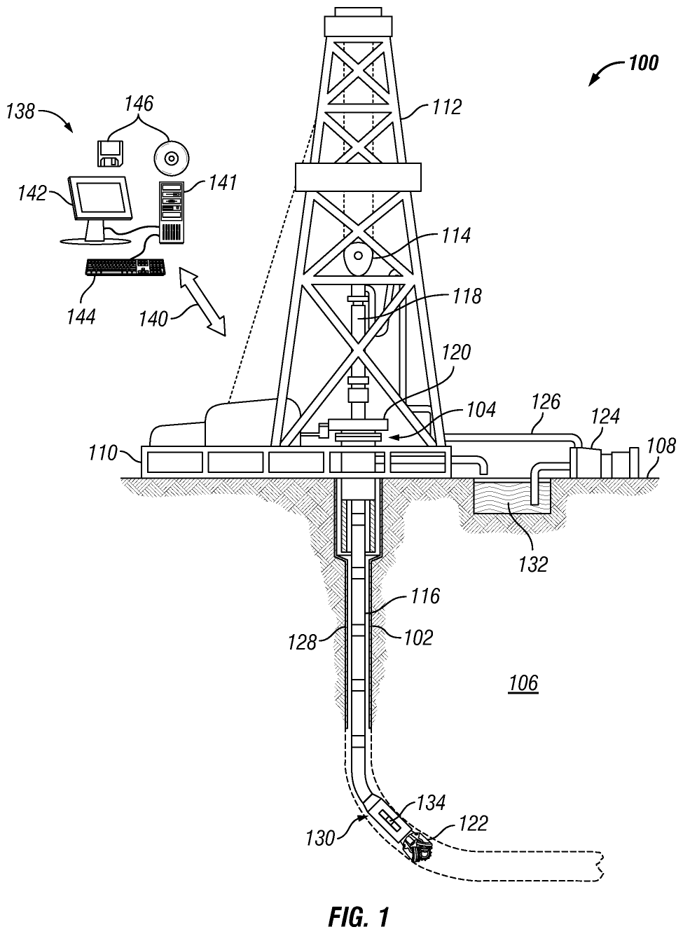

FIG. 1 illustrates a drilling system 100 in accordance with example embodiments. As illustrated, borehole 102 may extend from a wellhead 104 into a subterranean formation 106 from a surface 108. Generally, borehole 102 may include horizontal, vertical, slanted, curved, and other types of borehole geometries and orientations. Borehole 102 may be cased or uncased. In examples, borehole 102 may include a metallic member. By way of example, the metallic member may be a casing, liner, tubing, or other elongated steel tubular disposed in borehole 102.

As illustrated, borehole 102 may extend through subterranean formation 106. As illustrated in FIG. 1, borehole 102 may extend generally vertically into the subterranean formation 106, however borehole 102 may extend at an angle through subterranean formation 106, such as horizontal and slanted boreholes. For example, although FIG. 1 illustrates a vertical or low inclination angle well, high inclination angle or horizontal placement of the well and equipment may be possible. It should further be noted that while FIG. 1 generally depicts land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 may be attached to the distal end of drill string 116 and may be driven either by a downhole motor and/or via rotation of drill string 116 from surface 108. Without limitation, drill bit 122 may include, roller cone bits, PDC bits, natural diamond bits, any hole openers, reamers, coring bits, and the like. As drill bit 122 rotates, it may create and extend borehole 102 that penetrates various subterranean formations 106. A pump 124 may circulate drilling fluid through a feed pipe 126 through kelly 118, downhole through interior of drill string 116, through orifices in drill bit 122, back to surface 108 via annulus 128 surrounding drill string 116, and into a retention pit 132.

With continued reference to FIG. 1, drill string 116 may begin at wellhead 104 and may traverse borehole 102. Drill bit 122 may be attached to a distal end of drill string 116 and may be driven, for example, either by a downhole motor and/or via rotation of drill string 116 from surface 108. Drill bit 122 may be a part of bottom hole assembly (BHA) 130 at distal end of drill string 116. BHA 130 may further include tools for look-ahead resistivity applications. As will be appreciated by those of ordinary skill in the art, BHA 130 may be a measurement-while-drilling (MWD) or logging-while-drilling (LWD) system.

BHA 130 may comprise any number of tools, transmitters, and/or receivers to perform downhole measurement operations. For example, as illustrated in FIG. 1, BHA 130 may include a borehole logging tool 134. It should be noted that borehole sonic logging tool 134 may make up at least a part of BHA 130. Without limitation, any number of different measurement assemblies, communication assemblies, battery assemblies, and/or the like may form BHA 130 with borehole logging tool 134. Additionally, borehole logging tool 134 may form BHA 130 itself

Borehole logging tool 134 may be any suitable tool for taking measurements of borehole 102 or subterranean formation 106. For example, borehole logging tool 134 may be but is not limited to, an NMR tool, imaging tool, resistivity measurement tool, acoustic tool, neutron measurement-based tool, density measurement-based tool, and/or pulsed neutron measurement-based tool.

In examples, there may be any suitable number of, and type of sensors disposed on borehole logging tool 134. Each sensor may be controlled by information handling system 138. Information and/or measurements may be processed further by information handling system 138 to determine properties of borehole 102, fluids, and/or subterranean formation 106.

Without limitation, BHA 130 may be connected to and/or controlled by information handling system 138, which may be disposed on surface 108. Without limitation, information handling system 138 may be disposed downhole in BHA 130. Processing of information recorded may occur downhole and/or on surface 108. Processing occurring downhole may be transmitted to surface 108 to be recorded, observed, and/or further analyzed. Additionally, information recorded on information handling system 138 that may be disposed downhole may be stored until BHA 130 may be brought to surface 108. In examples, information handling system 138 may communicate with BHA 130 through a communication line (not illustrated) disposed in (or on) drill string 116. In examples, wireless communication may be used to transmit information back and forth between information handling system 138 and BHA 130. Information handling system 138 may transmit information to BHA 130 and may receive as well as process information recorded by BHA 130. In examples, a downhole information handling system (not illustrated) may include, without limitation, a microprocessor or other suitable circuitry, for estimating, receiving and processing signals from BHA 130. Downhole information handling system (not illustrated) may further include additional components, such as memory, input/output devices, interfaces, and the like. In examples, while not illustrated, BHA 130 may include one or more additional components, such as analog-to-digital converter, filter and amplifier, among others, that may be used to process the measurements of BHA 130 before they may be transmitted to surface 108. Alternatively, raw measurements from BHA 130 may be transmitted to surface 108.

Any suitable technique may be used for transmitting signals from BHA 130 to surface 108, including, but not limited to, wired pipe telemetry, mud-pulse telemetry, acoustic telemetry, and electromagnetic telemetry. While not illustrated, BHA 130 may include a telemetry subassembly that may transmit telemetry data to surface 108. At surface 108, pressure transducers (not shown) may convert the pressure signal into electrical signals for a digitizer (not illustrated). The digitizer may supply a digital form of the telemetry signals to information handling system 138 via a communication link 140, which may be a wired or wireless link. The telemetry data may be analyzed and processed by information handling system 138.

As illustrated, communication link 140 (which may be wired or wireless, for example) may be provided that may transmit data from BHA 130 to an information handling system 138 at surface 108. Information handling system 138 may include a personal computer 141, a video display 142, a keyboard 144 (i.e., other input devices.), and/or non-transitory computer-readable media 146 (e.g., optical disks, magnetic disks) that can store code representative of the methods described herein. In addition to, or in place of processing at surface 108, processing may occur downhole. Information handling system 138 may process measurements taken by borehole logging tool 134.

Discussed below are methods for processing measurements recorded during drilling operations to improve measurement data quality. As disclosed below, proposed algorithms may be implemented in a post-acquisition processing software. As detailed below post-acquisition processing software or in-situ software may be implemented on learning systems. Learning systems may include but are not limited to any type of Neural Networks (NN), Artificial intelligence (AI), and/or machine learning that may utilize databases and software training methods. In such case, software training may include one or more algorithms utilized to find an answer product. Algorithm discussed below may be utilized with or without machine learning to select measurement data from borehole logging tool 134 during a “pipe break.”

A pipe break is defined as the pausing of drilling operations. Pausing of drilling operations may occur when drill pipe is suspended “in slips” on the rig floor, circulating mud pumps are turned off, and the kelly and/or drill pipe above the rig floor is unscrewed from the suspended drill pipe. During Drilling or Trip In operations a new section of drill pipe and/or the Kelly is reattached to the suspended drill pipe, circulating pumps are turned back on, and then the drilling assembly lifted “out of slips”, and Trip In and Drilling operations may recommence. For Trip Out operations, drill pipe is stacked in the rig or laid down before lowering the block and lifting the next section drill pipe to be removed. Mud pump may or may not be started. The pipe break may also be referred to as a “unique station,” described in detail below.

Pipe breaks may further be identified as unique stations for acquiring data downhole. For example, data may continue to be collected by a logging tool disposed on BHA 130 at these unique stations. This data may be free of noise and other issues associated with taking measurements in a downhole environment during drilling operations. The measurements taken may be referred to as non-motion measurements. It should be noted, generally, measurements are not taken at these unique stations because the drilling operation has been shut down. A shut down drilling operation prevent the generation of electricity at BHA 130 through turbines and other similar methods. However, BHA 130 in this example includes one or more batteries disposed in BHA 130 that may power borehole logging tool 134. This may allow borehole logging tool 134 to continue to operate at these unique stations during pipe breaks. Generally, current technology does not include batteries in borehole logging tool 134 as they take up space inside BHA 130. During post processing, pipe breaks may be identified by viewing depth change of borehole logging tool 134 (e.g., referring to FIG. 1) with respect to time, which may be denoted at Depth(t). For example, when stationary, the corresponding derivative should be zero, as seen below.

$$( \frac{\partial Depth ( t )}{\partial t} ) = 0 \qquad ( 1 )$$

However, measurements taken with borehole logging tool 134 may include noise and/or accuracy of measurements such as depth of borehole logging tool 134, type of measurement, and/or time. In examples, if depth of borehole logging tool 134 may be measured precisely, not all data points that match Equation (1) correspond to a pipe break. For example, borehole logging tool 134 may get stuck or stop moving for any number of reasons in borehole 102 (e.g., referring to FIG. 1). Thus, the algorithm may be able to filter out depth measurements, noise, and pseudo pipe breaks. This may be done by utilizing multi-sensor data in borehole logging tool 134, for example, magnetometer, gyro and accelerometer together with depth measurement taken by borehole logging tool 134. During post-processing of in-situ processing, with or without machine learning, additional mathematical filters and software training may be applied. An example of a filter and software training may be the use of a sum of absolute depth derivative.

During data processing, “stations” are identified in measurements, which are used to improve measurement data. For this disclosure, an individual “station” is defined as a minimal set of contiguous events where the depth does not change. For example, the algorithm may perform a “depth difference” operation to find all locations within borehole 102 in which borehole logging tool 134 (e.g., referring to FIG. 1) recorded a depth difference vector measurement at 0. During processing operations, some locations with the depth difference vector measurement at 0 are removed. This is because the measurements at 0 do not meet a minimal number of contiguous events. Each of the resulting locations would be considered a “station.” In examples, locations where the depth difference vector is a very small non-zero value may also be considered a station. As discussed above, the post-processing or in-situ processing may be performed by machine learning instead of the 0 or small depth difference value and minimum number of contiguous events.

To help identify depth difference vector measurements at 0, multiple sensor data may be used, for example depth measurements, accelerometer measurements, RPM measurements, and/or the like taken with borehole logging tool 134 (e.g., referring to FIG. 1). Additionally, statistical models may be used to identify stations during processing. For example, during processing a nominal time T is calculated by looking at distribution of absolute depth derivative, RPM distribution, and accelerometer at zero (or close to zero). Then, moving integration of above sensor data with nominal time frame is used to find stations. This is performed by identifying integration values that are less or equal to a small value delta, which is computed by using any suitable statistical mode to produce a certain confidence level as a threshold. For example, the threshold may be example 95%.

Information handling system 138 (e.g., referring to FIG. 1) may automatically select, extract, and process stationary data events with minimal input parameter criteria. As discussed above, machine learning may be implemented (using one or more information handling system 138) to use multi-sensor data, for example, to perform mathematical operations such as regression with cross validation, which may be used to find time intervals and depths for stations, and corresponding parameters. Other methods may utilize invention algorithms to extract data during a data load step and process the resulting data with other mathematical operations such as Echo Stacking, Echo Phase Rotation, Depth Binning, Merging, and Inversion at each station individually for the case of NMR acquired data.

During processing operations, information handling system 138 (e.g., referring to FIG. 1) may automatically identify pipe break time intervals as unique stations. Unique set stations may be extracted from acquired data where all activities are considered along with depth differences equal to zero which may occur during pipe breaks, along with a user selectable nominal time spent while “stationary”. Users will also have the option to set a delta depth parameter with information handling system 138, which may also be used to train machine learning, to a small non-zero value when considering non-zero depth differences. The delta depth parameter is a parameter set by the user prior to performing quasi-station data extraction algorithm during the load data step. For example, the load data step may include echo loading, where identified stationary data may be used to estimate noise level. Noise level may be influenced by mud and formation (loading effect), and therefore corresponding parameters may be estimated in inversion by information handling system 138 or the utilization of machine learning.

Results from the processing may be compared to standard LWD log results. For example, stationary data (discussed above) may be compared with data at the same depth from same tool with motion or result from other tools. This may be performed, typically, via standard plotting tools, such processing may be performed via side-by-side plots in existing Post-Acquisition software or after exporting data to a Petrophysical software package and plotting stationary curves as single point markers along with standard LWD log curves in the same track.

Additionally, pipe break stationary data and corresponding standard LWD data may be processed together to improve standard LWD log quality. Information handling system 138 (e.g., referring to FIG. 1) or machine learning may also perform quality control (QC) processing for pipe break data and corresponding drilling data. QC processing may be performed by taking stationary data and comparing it with non-stationary data, either from borehole logging tool 134 (e.g., referring to FIG. 1) or other tools. Data after QC processing may be close to the same depth measurements when hardware and data processing is working properly. QC processing may also utilize measurements from trip in, trip out, and circulating activities in addition to drilling activities for QC in regard to data measurements.

As discussed above, data measurements are processed using algorithm that are performed by information handling system 138 (e.g., referring to FIG. 1) and, in examples, in conjunction with machine learning. FIG. illustrates an example of a machine learning system, specifically, a neural network (NN). It should be noted that this is only an example, and many other forms of machine learning may be utilized.

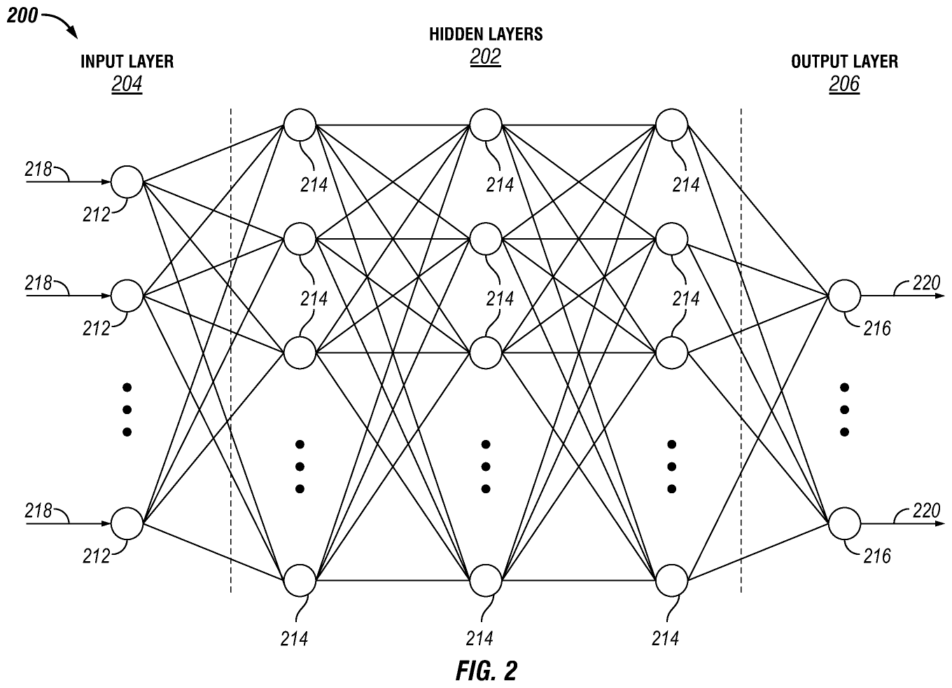

As illustrated in FIG. 2, a NN 200 is an artificial neural network with one or more hidden layers 202 between input layer 204 and output layer 206. In examples, NN 200 may be software on a single information handling system 138 (e.g., referring to FIG. 1). In other examples, NN 200 may software running on multiple information handling systems 138 connected wirelessly and/or by a hard-wired connection in a network of multiple information handling systems 138. As illustrated, input layer 204 may include measurement data 218 from borehole logging tool 134 (e.g., referring to FIG. 1), and output layers 206 may be answer products 220 from the processing discussed above. During operations, measurement data 218 is given to neurons 212 in input layer 204. Neurons 212 are defined as individual or multiple information handling systems 138 connected in a network, which may compute the measurement data into graphs and/or figures using the processing techniques discussed above. The output from neurons 212 may be transferred to one or more neurons 214 within one or more hidden layers 202. Hidden layers 202 includes one or more neurons 214 connected in a network that further process information from neurons 212 according to processing techniques discussed above. The number of hidden layers 202 and neurons 212 in hidden layer 202 may be determined by an operator that designs NN 200. Hidden layers 202 is defined as a set of information handling system 138 assigned to specific processing steps identified above. Hidden layers 202 spread computation to multiple neurons 214, which may allow for faster computing, processing, training, and learning by NN 200. Computations from neurons 214 may be consolidated by neurons 216 in output layer 206. Neurons 216 may form an answer product 220, or a plurality of answer products 220 for review by a user.

An answer product 220 may be generally identified as “logs.” In examples, answer products 220 as logs generally include raw log measurements, directly derived computed curves from those raw measurements, as well as applying more complicated algorithms to produce more advanced answer products. Additionally, some Quality Control indicators may be computed or derived and included in answer products 220. Various answer products 220 may be related to a particular tool or small set of tools used to acquire the data. In addition, some “integrated” answer products 220 may be produced by computing outputs from input curves directly or indirectly derived or computed form two or more logging tools.

For example, a standard Porosity and Water Saturation answer product 220 may be derived from a Triple Combo set of logging tools. This may include Neutron and Density tools along with a Resistivity tool. The Neutron and Density tools may provide their own individual Porosity logs. When Neutron and Density porosities are combined, a Cross-plot Porosity log may be formed. The Cross-plot porosity with Resistivity measurements may be combined to compute Water Saturation. Likewise, a Gamma Ray tool may provide a Shale and/or Clay volume which may then be used to compute a better Water Saturation output in some hydrocarbon bearing reservoirs.

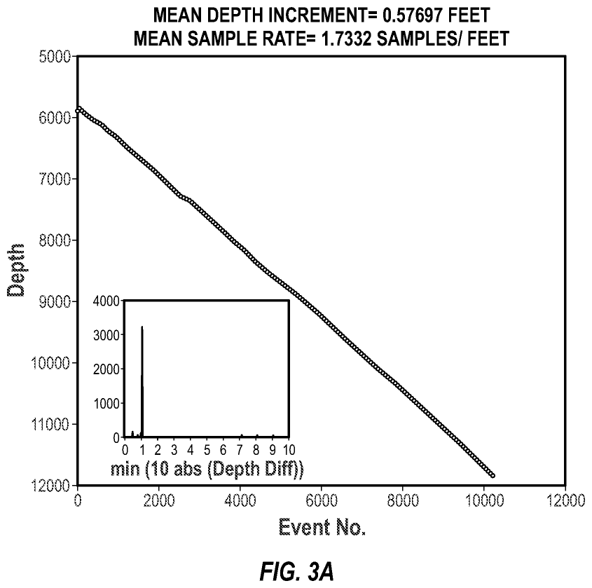

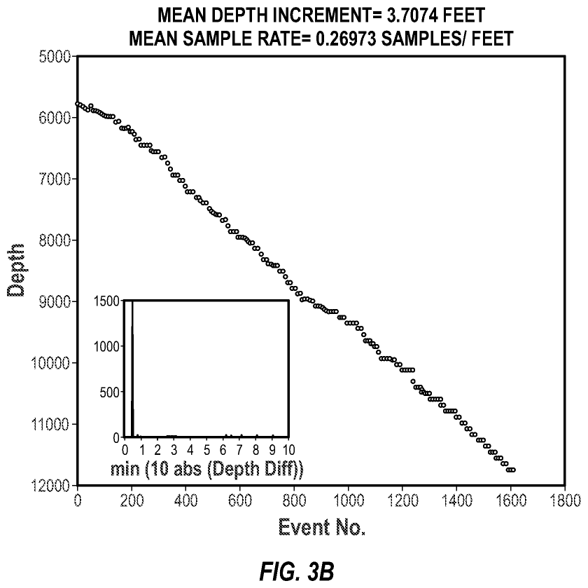

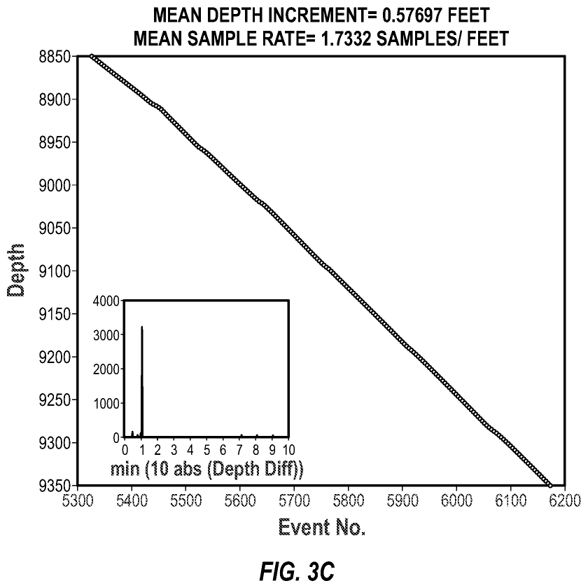

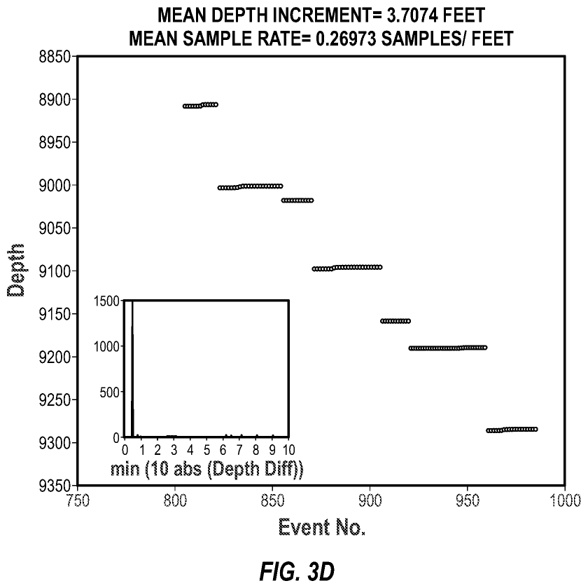

FIGS. 3A-3D are depth plots generated in the Post-Acquisition Processing software (using information handling system 138 or machine learning) during the Data Loading step when loading the data from the Acquisition System. The Depth Plots are used to inform the user of the location and number of quasi-stations extracted from the data for the algorithm specific parameter and criteria used. The specific measurement data utilize in FIGS. 3A-3D is from an NMR tool, however, the measurement data may be graphed the same way utilizing any number of measurement tools. As illustrated, each acquisition event is “tagged” with a Time in the tool downhole and then additionally “tagged” with Depth and Time-Depth Activity (TDA) when the tool's memory is read in post-processing or in-situ. For NMR tools, an NMR “group” is typically defined as have a common unique set of NMR Acquisition parameters including Wait Time (TW), Echo Spacing (TE), Number of Echoes (NE), and Operating Frequency. One or more NMR groups may also be acquired in a time-based sequence that repeats continuously.

FIG. 3A shows the above-described processing techniques for finding and displaying the NMR depths, for NMR “group” A, when the TDA is set to “Drilling”. Other Depth-Event filter may be applied including Start and Stop Time, Start and Stop Depth, as well as one of more Time-Depth Activities. Time-Depth Activities may be auto set at the rig and may include activities such as “Drilling”, “Trip In”, “Trip Out”, “Circulating”, and “None” as well as user defined activities to uniquely describe any out of the ordinary Time-Depth Activity operations. For this example, no Start or Stop Time, nor Start or Stop filter was applied. Only a “Drilling” TDA filter was applied. FIG. 3B shows a Depth Plot after applying the proposed quasi station extraction method using the default Quasi-Stationary Data Extraction Method parameters, described above. FIG. 3C displays the same data as shown in FIG. 3A but “zoomed in” to show more detail. FIG. 3D displays the same data as shown in 3B but “zoomed in” to show more detail.

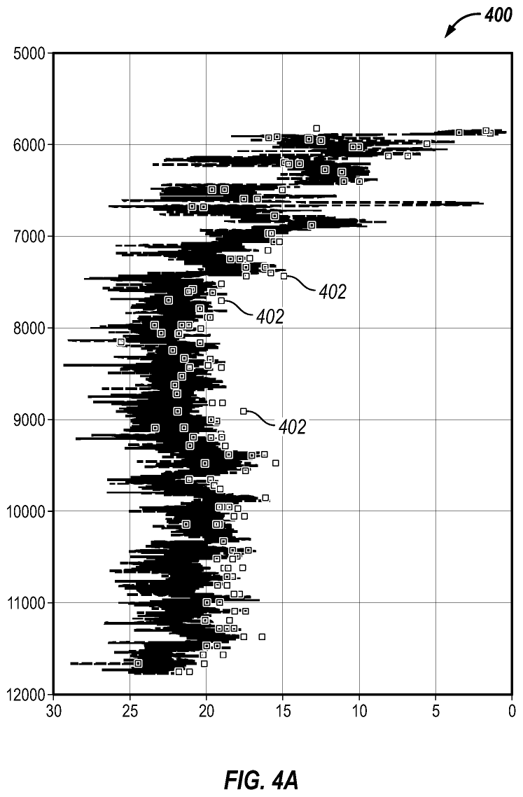

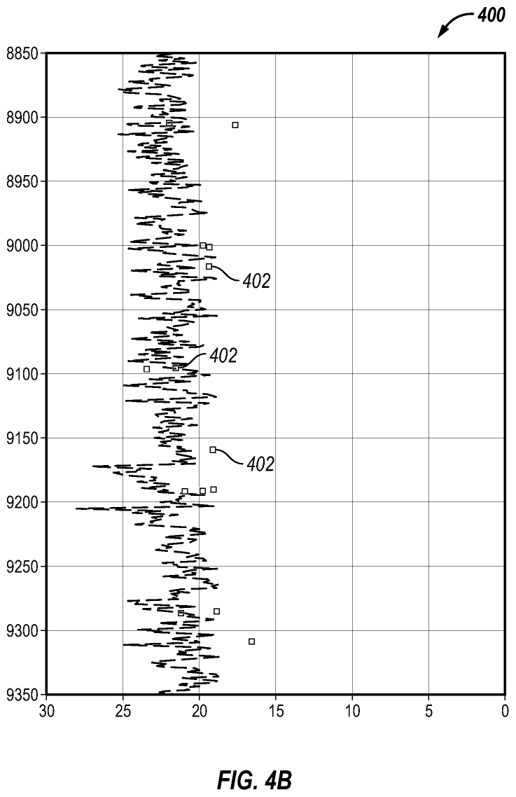

FIG. 4A illustrates a drilling log 400 that includes measurements of a logging tool from a depth of 5,000 feet to 12,000 feet. The graph illustrates standard data processing results from all measured events. Items 402 are quasi-stationary data that has been processed. FIG. 4B zooms into the graph of FIG. 4A, specifically on depths 8,850 feet to 9,350 feet. Items 403 are illustrated and represent quasi-stationary data that has been processed.

The systems and methods described above are an improvement over current technology. Specifically, measurement data logs include “station” data and “pipe break” data. This may allow for parameters within the measurement data logs to be accurately estimated with higher confidence level as to the accuracy. Accuracy issues are and have been a hindrance to current technology in data processing. Additionally, the used of an information handling system with machine learning and the algorithms disclosed above may allow for the automatic extraction of “stations” resulting from the identification and processing of “pipe breaks” to improve data measurements with minimal user input. For example, the automatic identification of “stations” may be performed by location in measurement data zero or minimal movement effects where standard “depth event” may be located. These standard depth events may include varying levels of rotational, lateral, axial, and vibrational movement effects. Corrections for these movement effects are prone to error as they are not always perfect as well as the errors associated with the measurements and parameters that are used to compute those corrections. Additionally, improved Signal-to-Noise ratio (SNR) may be performed by “stacking” several events in each station compared to stacking across a limited number of depths in standard “depth event” processing. The use of the proposed algorithm to extract more high-quality information from current and previously acquired data, thus improving the quality of the answer product for legacy. The extra information extracted improves log quality, acquired data, and the subsequent processing of that data. The preceding description provides various examples of the systems and methods of use disclosed herein which may contain different method steps and alternative combinations of components.

Statement 1. A method for a logging operation may comprise disposing a borehole logging tool into a borehole, wherein the borehole logging tool is disposed on a bottom hole assembly (BHA). Additionally, the method may include, taking one or more measurements at one or more depths in the borehole with the borehole logging tool to form a measurement data set, identifying one or more stations in the measurement data set, extracting the one or more stations from the measurement data set to form an extracted measurement data set, and providing one or more answer products from the extracted measurement data set.

Statement 2. The method of statement 1, wherein the one or more stations are defined as pipe breaks.

Statement 3. The method of statement 2, wherein the pipe breaks are defined as pausing drilling operations.

Statement 4. The method of statements 1 or 2, identifying pipe breaks using

$$( \frac{\partial Depth ( t )}{\partial t} ) = 0 ,$$

wherein Depth(t) is a depth of the drilling operation at a specified time.

Statement 5. The method of statements 1, 2, or 4, wherein the identifying the one or more stations in the measurement data set includes identifying when a depth difference vector measurement is 0.

Statement 6. The method of statement 5, further comprising identifying a depth difference vector measurement using an accelerometer or measuring revolutions per minute of the BHA.

Statement 7. The method of statement 6, further comprising training a neural network to identify the one or more stations with a training set.

Statement 8. The method of statement 7, wherein a training set includes identifying pipe breaks using

$$( \frac{\partial Depth ( t )}{\partial t} ) = 0 ,$$

wherein Depth(t) is a depth of the drilling operation at a specified time.

Statement 9. The method of statements 1, 2, 4, or 5, further comprising producing one or more answer products, wherein the one or more answer products are raw log measurements.

Statement 10. The method of statements 1, 2, or 4 - 6, wherein the BHA includes one or more batteries disposed inside the BHA.

Statement 11. A system for a logging operation may comprise a bottom hole assembly (BHA) disposed on a drill string, configured to take one or more measurements at one or more depths in a borehole with a borehole logging tool disposed on the BHA to form a measurement data set. The system may further include an information handling system connected to the BHA and configured to identify one or more stations in the measurement data set, extract the one or more stations from the measurement data set to form an extracted measurement data set, and provide one or more answer products from the extracted measurement data set.

Statement 12. The system of statement 11, wherein the one or more stations are defined as pipe breaks.

Statement 13. The system of statement 12, wherein the pipe breaks are defined as pausing drilling operations.

Statement 14. The system of statement 11 or 12, wherein the information handling system is further configured to identify pipe breaks using

$$( \frac{\partial Depth ( t )}{\partial t} ) = 0 ,$$

wherein Depth(t) is a depth of the drilling operation at a specified time.

Statement 15. The system of statements 11, 12, or 14, wherein the one or more stations in the measurement data set include identifying when a depth difference vector measurement is 0.

Statement 16. The system of statement 15, wherein the information handling system is further configured to identify a depth difference vector measurement using an accelerometer or measuring revolutions per minute of the BHA.

Statement 17. The system of statement 16, wherein the information handling system is further configured to train a neural network to identify the one or more stations with a training set.

Statement 18. The system of statement 17, wherein a training set includes identifying pipe breaks using

$$\partial ( \frac{Depth ( t )}{\partial t} ) = 0 ,$$

wherein Depth(t) is a depth of the drilling operation at a specified time.

Statement 19. The system of statements 11, 12 ,14, or 15, further comprising identifying one or more answer products, wherein the one or more answer products are raw log measurements.

Statement 20. The system of statement 19, wherein the BHA includes one or more batteries disposed inside the BHA.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for a logging operation comprising:
disposing a borehole logging tool into a borehole, wherein the borehole logging tool is disposed on a bottom hole assembly (BHA);
taking one or more measurements at one or more depths in the borehole with the borehole logging tool to form a measurement data set;
identifying one or more stations in the measurement data set;
extracting the one or more stations from the measurement data set to form an extracted measurement data set; and
providing one or more answer products from the extracted measurement data set.

2. The method of claim 1, wherein the one or more stations are defined as pipe breaks.

3. The method of claim 2, wherein the pipe breaks are defined as pausing drilling operations.

4. The method of claim 1, identifying pipe breaks using
$$( \frac{\partial Depth ( t )}{\partial t} ) = 0 ,$$
wherein Depth(t) is a depth of the drilling operation at a specified time.

5. The method of claim 1, wherein the identifying the one or more stations in the measurement data set includes identifying when a depth difference vector measurement is 0.

6. The method of claim 5, further comprising identifying a depth difference vector measurement using an accelerometer or measuring revolutions per minute of the BHA.

7. The method of claim 6, further comprising training a neural network to identify the one or more stations with a training set.

8. The method of claim 7, wherein a training set includes identifying pipe breaks using
$$( \frac{\partial Depth ( t )}{\partial t} ) = 0 ,$$
wherein Depth(t) is a depth of the drilling operation at a specified time.

9. The method of claim 1, further comprising producing one or more answer products, wherein the one or more answer products are raw log measurements.

10. The method of claim 1, wherein the BHA includes one or more batteries disposed inside the BHA.

11. A system for a logging operation comprising:
a bottom hole assembly (BHA) disposed on a drill string, configured to take one or more measurements at one or more depths in a borehole with a borehole logging tool disposed on the BHA to form a measurement data set;
an information handling system connected to the BHA and configured to:
identify one or more stations in the measurement data set;
extract the one or more stations from the measurement data set to form an extracted measurement data set; and
provide one or more answer products from the extracted measurement data set.

12. The system of claim 11, wherein the one or more stations are defined as pipe breaks.

13. The system of claim 12, wherein the pipe breaks are defined as pausing drilling operations.

14. The system of claim 11, wherein the information handling system is further configured to identify pipe breaks using
$$( \frac{\partial Depth ( t )}{\partial t} ) = 0 ,$$
wherein Depth(t) is a depth of the drilling operation at a specified time.

15. The system of claim 11, wherein the one or more stations in the measurement data set include identifying when a depth difference vector measurement is 0.

16. The system of claim 15, wherein the information handling system is further configured to identify a depth difference vector measurement using an accelerometer or measuring revolutions per minute of the BHA.

17. The system of claim 16, wherein the information handling system is further configured to train a neural network to identify the one or more stations with a training set.

18. The system of claim 17, wherein a training set includes identifying pipe breaks using
$$\partial ( \frac{Depth ( t )}{\partial t} ) = 0 ,$$
wherein Depth(t) is a depth of the drilling operation at a specified time.

19. The system of claim 11, further comprising identifying one or more answer products, wherein the one or more answer products are raw log measurements.

20. The system of claim 19, wherein the BHA includes one or more batteries disposed inside the BHA.
